(19) United States
(12) Patent Application Publication
(10) Pub. No.: US 2015/0299411 A1
(43) Pub. Date: Oct. 22, 2015

(54) FOAMABLE COMPOSITION WITH LOW HEAT CONDUCTIVITY FOR USE IN PROFILED PLASTIC PARTS

(71) Applicant: SIKA TECHNOLOGY AG, Baar (CH)

(72) Inventors: Herbert ACKERMANN, Tann (CH); Frank HOEFFLIN, Baden (CH); Andreas BRUNNER, Rafz (CH)

(21) Appl. No.: 14/385,066

(22) PCT Filed: Mar. 12, 2013
(86) PCT No.: PCT/EP2013/055028

§ 371 Date: Sep. 12, 2014

(30) Foreign Application Priority Data
Mar. 20, 2012 (EP) 12160394.8

(51) Int. Cl. C08J 9/10; C08J 9/00

(52) U.S. Cl. CPC C08J 9/103; C08J 9/0033; C08J 2323/06

(57) ABSTRACT

A foamable composition is described that includes at least one base polymer, at least one propellant, at least one lubricant and/or at least one heat stabilizer, and optionally additional additives, selected from crosslinking agents, heat reflectors, heat flow additives, anti-condensation additives, and/or fillers. Corresponding compositions can be processed into polymer foams which can have a heat conductivity of <0.04 E(mK), and an expansion greater than or equal to 1000%, and a weldability of 80 seconds at 240-260° C. Corresponding polymer foams can be advantageously introduced into hollow profiled plastic parts for windows and doors using a coextrusion process and can thus be used to produce door and window frames with low conductivity values.

### TECHNICAL FIELD

The invention relates to a foamable composition with high expansion volume and low heat conductivity, which is particularly suitable as filling material for hollow spaces for windows, doors and the like. The invention further relates to a polymer foam, which is characterized by a low heat conductivity, a high expansion as well as an advantageous weldability.

The invention also relates to profiled plastic parts comprising at least one hollow space into which a foamable composition as described above has been introduced. Finally, the invention relates to a method for manufacturing profiled plastic parts, wherein a foamable composition is introduced, during the extrusion of the profiled plastic part, into at least one of the hollow spaces of the profiled part and foamed.

### PRIOR ART

The door and window industry in recent years has had to adjust to constantly new requirements relating to improved thermal insulation of windows and doors. This is reflected in increasingly stringent guidelines, among other factors, that confront the window manufacturers and their suppliers with ever increasing challenges.

Traditionally, for the purpose of stiffening extruded hollow profiled plastic parts, profiled steel parts are inserted into the hollow cavity of a hollow profiled plastic part in order to achieve sufficient stiffness of the profiled parts. Such profiled plastic parts are used, for example, as frames and/or leaf profiles of windows, doors and the like. The plastic used here is usually polyvinyl chloride (PVC). However, one disadvantage of profiled plastic parts reinforced with profiled steel parts is that the heat insulation is considerably impaired by the use of metal inside the profiled plastic part. This is the result of the high heat conductivity of metals, particularly steel. In order to achieve improved heat insulation, the hollow chamber of the profiled steel part, which is inserted into the profiled plastic part, is filled with a foamable material, for example, with a polyurethane foam. However, filling a hollow chamber at a later time with foam has been found to be very inconvenient, since window profiles are usually extruded in a length of several meters and the filling with foam has to be carried out using a long tube. However, due to the low stiffness, it is impossible to omit profiled metal parts for reinforcing profiled plastic parts without using a substitute.

In order to be able, nevertheless, to largely do without metal in the interior of the profiled plastic part, thermally insulating reinforcement profiled parts that are manufactured from fiber-reinforced plastics and filled with polymer foam have been used recently for reinforcement. This has the additional advantage that foams have better thermal properties compared to air. Especially in larger windows, the air circulation and the associated heat transport can be effectively suppressed by means of foams.

For example, weldable profiled parts that are filled with two-component polyurethane foams and in which the hollow spaces of finished profiled parts are filled with polyurethane foam have been proposed. For this purpose, the two polyurethane components are injected at high pressure into the hollow spaces of the profiled part by means of long spraying devices and foamed. However, it is problematic with these systems that, in the case of polyurethanes, it is not simple to achieve complete reaction of the isocyanate monomers. This has an impact on the later processability of corresponding window profile parts, since residual isocyanate monomers can be released at the time of the cutting to size and adaptation of the profiled parts. In order to prevent this, additional safety measures have to be taken and expensive insurance policies have to be taken out. In addition, the polyurethane components have to be stored on site, and care must be taken to prevent exposure to these compounds during storage. Finally, two-component polyurethane systems have the disadvantage that they have to be classified in a lower fire-protection class due to potentially free isocyanate.

In an alternative approach, expanded polystyrene foams are described, in which the foam body is produced first outside of the window profile parts and subsequently inserted into a profiled part. However, this alternative as well has the disadvantage that a two-step method for manufacturing such profile parts is associated with high cost and that manufacturing precisely fitting foam bodies requires additional equipment.

WO 2009/062986 A1 proposes a solution to this problem, according to which a foamable material in the form of a granulate is introduced, during the extrusion of a profiled PVC part, into the hollow space of the profiled part. As a result of contact with the still hot profiled part, a propellant contained in the granulate is activated, and foaming of the material in the still hot profiled PVC part is achieved. In this method, the foam has to be incompatible with the plastic of the profiled part, since otherwise undesired adhesion of the foam to the plastic would occur. However, it has been found to be problematic in this procedure that the hollow space in the profiled part cannot be filled completely with compositions that consist essentially of a foamable base polymer and a propellant, since foaming occurs only at the time of contact with the surface of the hollow profiled part. This leads partially to the impossibility of uniformly filling the frame profile.

As an additional problem that occurs during the foaming within an extruded and thus still hot profiled part, it has been found that thin wall profile parts in particular can undergo strong deformation during the expansion of the foam. Finally, a disadvantage of existing foam compositions is that the foam contracts again during the cooling, so that complete filling of the hollow space with foam is difficult to guarantee, and hollow spaces form which increase the heat conductivity of the profiled part.

### DESCRIPTION OF THE INVENTION

The invention is therefore based on the problem of providing a foamable composition which can be introduced directly into the still hot extruded profiled part during the manufacture of profiled plastic parts, and which thus represents a more cost effective alternative to the subsequent “sliding-in” of preformed foams into the profiled part. At the same time, the constitution of the foam should be such that it fills the hollow space as uniformly as possible during the foaming, without significantly deforming the wall profiles, and without noticeably contracting during the cooling. According to the invention, this is achieved by a foamable composition according to the first claim.

The core of the invention accordingly is a foamable composition which comprises at least one base polymer, at least one propellant, as well as at least one lubricant and/or at least one heat stabilizer. The content of base polymer here should preferably be at least 50% by weight. Moreover, the base polymer should preferably be selected so that it is not compatible with the plastic of the profiled part and does not adhere to said plastic during foaming. In order to ensure sufficient foaming, a content of propellant in the range of 5 to 20% by weight has been found to be advantageous. The lubricant and/or the heat stabilizer is/are contained in the foamable composition in quantities of 0.1 to 5% by weight, relative to the foamable composition. By means of such a composition, polymer foams with a thermal conductivity of <0.04 W/(mK), an expansion of ≧1000%, in particular of ≧2000% and/or a weldability of approximately 80 sec at 240 to 260° C. can be produced.

Additional aspects of the invention relate to the use of the described foamable compositions for filling with foam hollow spaces in hollow bodies, as well as to foam-filled hollow bodies, in particular in the form of window or door profiles that comprise at least one hollow space into which a foamable composition as described above has been introduced and foamed, as well as to a method for manufacturing foam-filled hollow bodies, in which a foamable composition as described above is introduced into at least one hollow space of the hollow body and foamed.

The advantages of the invention include, among others that the foamable composition is not introduced only at a later time but is already introduced, during the extrusion of a profiled plastic part, into at least one of the hollow spaces of the profiled part. Moreover, the improved mechanical properties and the improved heat insulation of the profiled plastic parts are advantageous. These properties can be influenced additionally by the selection of the foamable material. An additional advantage of the polymer foams according to the invention is their extraordinarily high expansion of ≧1000%, in particular of ≧2000%, which is maintained even during heat treatment of longer duration. In addition, the foams according to the invention are characterized by an advantageous heat conductivity of <0.04 W/(mK) and a weldability of approximately 80 seconds at 240 to 260° C. Finally, during the foaming of the foamable compositions according to the invention, no noticeable deformation of the profiled plastic parts occurs, and the volume of the foam decreases only insignificantly during cooling.

### BRIEF DESCRIPTION OF THE DRAWINGS

Further advantages and advantageous uses of the invention appear from the following description of embodiment examples and aspects, partially in reference to FIG. 1.

FIG. 1 shows a diagrammatic representation for explaining an embodiment of the method according to the invention, in the form of a longitudinal sectional representation through a coextrusion arrangement.

### WAYS OF CARRYING OUT THE INVENTION

In the present document, substance names starting with “poly,” such as, for example, polyisocyanate, polyurethane, polyester or polyol, denote substances that formally contain two or more of the functional groups occurring in their name per molecule.

In the present document, the term “polymer” includes, on the one hand, a group of chemically uniform macromolecules which, however, differ in terms of polymerization degree, molecular weight and chain length, which was produced by a polyreaction (polymerization, polyaddition, polycondensation). In addition, the term also covers derivatives of such a group of macromolecules from polyreactions, that is to say compounds which were obtained by reactions such as additions or substitutions, for example, of functional groups on predetermined macromolecules and which can be either chemically uniform or chemically not uniform. The term moreover also covers so-called prepolymers, that is to say reactive oligomeric pre-adducts whose functional groups participate in the buildup of macromolecules.

In the context of the present invention, the term “heat stabilizer” should be understood to mean that the foam produced undergoes a significant volume reduction (10% or more) even in the case of a longer exposure (10 minutes or longer) to high temperatures (150° C. or more). Thus, the heat stabilizer stabilizes the foam produced against decomposition during processing. It is preferable for the heat stabilizer to act as a radical scavenger or an antioxidant.

In this document, the term “hollow profiled plastic part” (also referred to as “outer profile”) denotes an elongate hollow body made of plastic, whose length is as a rule substantially greater than its cross section. In a coextrusion method, in which a second material is coextruded into the interior of this hollow body, wherein the hollow body is filled completely, the term hollow profiled plastic part refers only to this outer plastic body. The inner material is referred to as “core.”

In the present document, the term “profiled plastic part” denotes the entire element, that is to say the hollow profiled plastic part including the core.

In the present document, the term “fatty acid” denotes linear aliphatic carboxylic acids that can comprise one or more double bonds. In this case, the fatty acids are also referred to as mono- and polyunsaturated fatty acids.

In the present document, the term “fatty acid alcohol” denotes fatty acid derivatives in which the carboxyl group characteristic of the fatty acid has been converted reductively into a —CH₂OH function.

In the present document, the term “foam-filled hollow body” denotes hollow bodies that can be filled either entirely or partially with a foam.

As base polymer of the foamable composition that can be used for producing cores of profiled plastic parts, it is possible in principle to use any desired material which can be made to foam in a controlled manner and which has reinforcement properties. The base polymer should preferably be incompatible with the material of the profiled part and not adhere to said material. It is particularly preferable for the foamable composition introduced into a profile not to adhere to PVC.

However, the base polymer is preferably an organic polymer having a melting point in the range of 20 to 400° C. The base polymer should advantageously soften at a temperature that is below the foaming temperature and allows its deformation during the foaming process. Once the foaming temperature has been reached, the base polymer is foamed. It is particularly preferable for the base polymer to have a melting point in the range of 60 to 200° C. Moreover, a possible curing process should preferably start only once the foaming temperature has been exceeded and the foaming has been completed at least partially.

The person skilled in the art is readily familiar with suitable base polymers. In the context of the present invention, it is particularly preferable to select the base polymer from the group including EVA, polyolefin, polyvinyl chloride or XPS (crosslinked polystyrene). Preferred polyolefins are ethylene- or propylene-based polymers, among which polyethylene, particularly in the form of LDPE (low density polyethylene), is particularly preferred. Mixtures of the mentioned polymers can also be used as base polymer in the context of the invention.

If the base polymer is PVC, then the latter can be fabricated with other polymers, in particular with a terpolymer made of ethylene, n-butyl acrylate and carbon monoxide, so that the foamable composition does not adhere to the material of the profiled part. If PVC is used as base polymer in connection with a profiled part made of PVC, it is also possible to allow or promote adhesion between the foamable composition and the material of the profiled part. In this case, profiled part and core material do not have to be separated for recycling, so that adhesion is not problematic.

The base polymer as a rule represents the main component of the foamable composition, wherein the proportion thereof in the composition is preferably at least 50% by weight. It is particularly preferable for the content of base polymer to be in the range of 65 to 95% by weight, in particular in the range of 70 to 90% by weight, and most preferably in the range of 75 to 85% by weight.

The foamable composition can be foamed thermally or by electromagnetic radiation. For this purpose, the foamable composition typically contains a chemical or physical propellant. Chemical propellants are organic or inorganic compounds that decompose under the influence of temperature, moisture or electromagnetic radiation, wherein at least one of the decomposition products is a gas. As physical propellants it is possible to use, for example, compounds that transition at increased temperature into the gaseous state of matter. As a result, both chemical and also physical propellants are capable of generating foam structures in polymers.

In connection with the present invention, it has been found to be particularly advantageous if the foamable composition is thermally foamable and is foamed at a temperature less than or equal to 250° C., particularly at a temperature of 100° C. to 230° C., preferably of 140° C. to 200° C., wherein chemical propellants are used. It has been found to be particularly advantageous to use azodicarbonamides, sulfohydrazides, hydrogen carbonates or carbonates as chemical propellants. Suitable azodicarbonamides are, for example, azobisformamide. Suitable sulfohydrazides are p-toluenesulfonyl hydrazide, benzenesulfonyl hydrazide and p,p′-oxobisbenzenesulfonyl hydrazide. A suitable hydrogen carbonate is sodium hydrogen carbonate. Particularly preferred propellants are azobisformamide and p,p′-oxybisbenzenesulfonyl hydrazide. Suitable propellants are also commercially available under the trade name Expancell® from the company Akzo Nobel, The Netherlands, under the trade name Cellogen® from the company Chemtura Corp., USA, or under the trade name Unicell® from the company Tramaco, Germany.

The heat required for the foaming can be supplied by external or by internal heat sources, such as an exothermic chemical reaction.

With regard to the content of propellant, the present invention is not subject to any relevant restrictions. However, it has been found to be advantageous if the propellant is contained in the foamable composition at a content of 5 to 20% by weight, in particular of 10 to 18% by weight, and particularly preferably in the range of 12 to 16% by weight, relative to the foamable composition. In cases in which a lower expansion value of the composition is desirable, the content can also be lower, in particular it can be in the range of 5 to 10% by weight.

The foamable composition from which the polymer foam can be produced contains, as described above, also at least one lubricant and/or at least one heat stabilizer. In a preferred embodiment, the foamable composition contains a component which at the same time has the properties of a lubricant and also those of a heat stabilizer. In this case, it is possible to dispense with the use of an additional lubricant or heat stabilizer component.

As heat stabilizers that confer at the same time a lubricant effect to the foamable composition, it has been found to be particularly suitable to use in particular fatty acid amides, fatty acids and fatty acid alcohol esters whose long aliphatic carbon chains produce the desired lubricant effect. At the same time, these compounds function as heat stabilizer. It has been found to be particularly advantageous to use fatty acid amides, fatty acids and fatty acid alcohol esters that have a chain length of the portion due to the fatty acid or to the fatty acid alcohol in the range of 6 to 24, preferably 8 to 16, and in particular 10 to 14 carbon atoms.

In the context of the invention, heat stabilizers comprising a thioether function in addition to a linear aliphatic chain have been found to be particularly suitable. Most preferable as heat stabilizers are fatty acid alcohol diesters in which a thioether function is present in the acid portion, in particular didodecyl 3,3′-thiodipropionate.

Other suitable heat stabilizers are conventional antioxidants, such as sterically hindered phenols, secondary thioethers or antioxidants based on phosphite, and sterically hindered amines, such as the so-called HALS [hindered amine light stabilizers], for example.

The heat stabilizer should be contained in the composition at least in a quantity at which a significant stabilization of the composition after the foaming is observed, i.e., so that the foam is not subjected to a significant volume reduction (10% or more) even in the case of longer exposure (10 minutes or longer) to high temperatures (150° C. or more). In the context of the present invention, a content of the heat stabilizer and/or of the lubricant in the range of 0.1 to 5% by weight, and preferably in the range of 0.5 to 3% by weight, relative to the total foamable composition, has been found to be particularly suitable. In the case of contents of less than 0.1% by weight, the quantity of the heat stabilizer is not sufficient to stabilize the foam, whereas in the case of contents of more than 5% by weight a significant decrease of the foam volume is also observed in the case of longer exposure of the foam to high temperatures.

Moreover, it has been found to be advantageous if the foamable composition is stabilized and consolidated during the foam formation. This can be ensured by adding crosslinking agents that are preferably activated by degradation products of the propellant and trigger a crosslinking of the forming foam. Here, the curing of the foamable composition should start only at a temperature that is equal to or higher than the foaming temperature thereof, because otherwise the curing of the foamable composition occurs before foaming thereof, and as a result it would not be possible to ensure that the foamable composition has filled the entire hollow space of the profiled plastic part before the curing and that the foam has a compact structure.

With regard to the crosslinking of the polymer foam obtained, the present invention is also not subject to any relevant limitations. A crosslinking of the foam is possible particularly by means of crosslinking agents, which do not react with the base polymer, such as, for example, epoxy-based crosslinking agents, or with the help of crosslinking agents which react with the base polymer. Peroxide crosslinking agents are an example of such a crosslinking agent. In the context of the present invention, a crosslinking with peroxide crosslinking agents or a crosslinking with epoxides is preferred.

In the crosslinking with peroxides, it is possible conventional organic peroxides, such as, for example, dibenzoyl peroxide, dicumyl peroxide, 2,5-di-(t-butylperoxyl)-2,5-dimethylhexane, t-butyl cumyl peroxide, a,a′-bis(t-butylperoxy)diisopropylbenzene isomer mixture, di(t-amyl)peroxide, di-(t-butyl)peroxide, 2,5-di-(t-butylperoxy)-2,5-dimethyl-3-hexyne, 1,1-di(t-butylperoxy)-3,3,5-trimethylcyclohexane, n-butyl 4,4-di-(t-butylperoxy)valerate, ethyl 3,3-di-(t-amylperoxy)butanoate or t-butyl peroxy-3,5,5-trimethyl hexanoate can be used. Dicumyl peroxide is a preferred peroxide.

When using epoxy-based crosslinking agents, a mixture of an epoxy-containing polymer and of a maleic acid anhydride group-containing polymer has been found to be particularly advantageous. The epoxy-containing polymer is preferably a polymer made of ethylene and glycidyl methacrylate with a glycidyl monomer content in the range of 4 to 12% by weight. The maleic acid anhydride group-containing polymer consists preferably of a terpolymer made of ethylene, an acrylic acid alkyl ester, in particular based on an alkyl alcohol having 2 to 10 carbon atoms, and maleic acid anhydride. The content of maleic acid anhydride in the terpolymer is preferably in the range of 1.5 to 5%. It is particularly preferable for these two crosslinking agent components to be present in a ratio from 2:1 to 1:2, particularly approximately 1:1.

This polymer combination has been found to be particularly advantageous especially in combination with propellants during the heating of which water or alcohol is released, since, due to the forming water or the alcohols, the maleic acid anhydride groups can be hydrolyzed to maleic acid, which in turn undergoes a reaction with the epoxy groups of the epoxy-containing polymer and brings about a crosslinking In the foamable composition, the crosslinking agent is contained preferably at a content of 1 to 25% by weight, in particular in the range of 2 to 18% by weight and particularly preferably in the range of 2 to 10% by weight, relative to the total foamable composition. However, if a peroxide is included as crosslinking agent then its concentration can also be lower, in particular in the range of 1 to 5% by weight and particularly preferably in the range of 1 to 2% by weight.

In a further preferred embodiment, the foamable composition is free of crosslinking agents.

Moreover, it has been found to be advantageous if, in addition, at least one heat reflector, at least one heat loss additive, at least one anticondensation additive, at least one antioxidant, urea and/or at least one filler is/are included the foamable composition. Graphite, carbon black and/or titanium dioxide represent(s) advantageous heat reflectors. Advantageous fillers to be included in the polymer foam are calcium carbonate or talc, which can be contained at a content from 0.5 to 8% by weight, in particular 1 to 5% by weight, and particularly preferably in a quantity of approximately 2% by weight, in the polymer foam. Fillers can be added, for example, as nucleation agents, in order to improve the foaming. Examples of suitable antioxidants are sterically hindered phenols.

A preferred foamable composition comprises

a) at least 50% by weight of at least one base polymer,

b) 5-20% by weight of propellant,

c) 0.1 to 5% by weight of at least one lubricant and/or at least one heat stabilizer, wherein additional additives, such as crosslinking agents, heat reflectors, heat loss additive and/or fillers can be contained. In a particularly preferred embodiment, the foamable composition consists substantially of the mentioned components, wherein the content of the base polymer corresponds to the remainder of the sum of all the components needed to reach 100% by weight.

An additional preferred foamable composition includes

a) at least 50% by weight of at least one base polymer,

b) 5 to 10% by weight of propellant,

c) 0.1 to 5% by weight of at least one lubricant and/or at least one heat stabilizer, and

d) 0.5 to 3% by weight of a peroxide crosslinking agent.

An additional preferred foamable composition includes

a) at least 50% by weight of at least one base polymer,

b) 8 to 20% by weight of propellant,

c) 1 to 3% by weight of at least one lubricant and/or at least one heat stabilizer, and

d) 1 to 5% by weight of a filler, in particular CaCO₃, and it contains no additional crosslinking agent.

A further aspect of the present invention relates to polymer foams that have a heat conductivity of <0.04 W(mK). Alternatively or additionally to this feature, the polymer foams can have an expansion of ≧1000%, in particular of ≧1500%, preferably of ≧2000%. Insofar as the weldability of the polymer foam is concerned, it is crucial that no residues remain on the welding mirror during the welding of, for example, PVC profiled parts that are filled with polymer foam. Moreover, the foams should preferably have a weldability of approximately 80 seconds at 240-260° C. In addition, the polymer foam or the foamable composition is preferably characterized by at least one of the properties listed below:

Recyclability

Minimal shrinkage behavior

No bending of crosspieces in the profiled part or deformation of chambers of the profiled part

No decrease of the corner strength

Water uptake analogously to PVC

Non-hazardous gas emission during the expansion

No or only minimal damage to PVC during the foaming process

No material buildup in the tool or tool attachment

Odorless

Long-term heat stability

No special work or storage instructions provided by the manufacturer of the profiled part.

In a particularly preferred embodiment, the foamable composition or the finished polymer foam has all the above-mentioned properties.

A further aspect of the present invention relates to hollow bodies with a hollow space in which a foamable composition, as described above, has been introduced and foamed. In particular, the hollow body preferably pertains to profiled plastic parts with suitable shapes for windows, doors, and for the door area, in particular around frames and/or leaf profiles. Moreover, it is preferable for the hollow space into which the foamable composition has been introduced to be filled, in particular completely filled, with the polymer foam that is formed.

In a design that is of special interest currently with regard to environmental protection aspects and economically, the hollow body is an extruded profiled part made of a plastic material, and the insulation material is introduced in a coextrusion process at the same time as the formation of the profiled plastic part. In principle, the invention is also usable with extruded profiled metal parts for window and door frames and furthermore with products of another type, for example, for in-situ sealing of joints or insulation of hollow spaces in parts of a structure or for the joint sealing and the insulation of profiled parts or other hollow spaces in vehicle, aircraft and ship construction.

Typically, it is suitable to use, as plastic for the manufacture of hollow profiled plastic parts, thermoplastically processable plastics, in particular polyvinyl chloride (PVC), preferably hard PVC (also referred to as PVC-U or “unplasticized PVC”), polypropylene (PP), polymethyl(meth)acrylate (PMMA), polycarbonate (PC) or other suitable thermoplastics. PVC, preferably hard PVC, is particularly suitable. One reason among others for this is the resistance to weathering of the PVC and the associated possibility of use in the open air.

Moreover, for manufacturing hollow profiled plastic parts, the plastic can contain additional components such as, for example, stabilizers, in particular light and heat stabilizers, impact strength modifiers, plasticizers, fire protection agents, antistatic agents, fillers, fibers, such as glass or carbon fibers, dyes or pigments.

In connection with the use of hard PVC, it is necessary to add stabilizers, since hard PVC is heat sensitive and its decomposition starts at temperatures of approximately 140° C.

Such hollow profiled plastic parts can be manufactured advantageously by a method in which a composition as described above is introduced, during the extrusion of the profiled part, into at least one of the hollow spaces of the profiled part and foamed.

According to a further aspect, the present invention relates in general to a method for manufacturing foam-filled hollow bodies, wherein a composition as described above is introduced, during the extrusion of the hollow body, into at least one hollow cavity of the hollow body and foamed.

In a particularly preferred embodiment of the method according to the invention, the manufacture of the foam is carried out by activating the propellant in the foamable composition under pressure and subsequent distribution of the composition into the hollow space of a hollow body, wherein the composition in the hollow space is expanded with a volume expansion gradient that is sufficiently high so that the insulation material formed by the expansion without delay completely fills the cross section of the hollow body or hollow space.

Thus, the already expanded insulation substance collides so to speak with the prefabricated hollow body or the existing hollow space, without having existed beforehand as an independent body elsewhere, and without having had to be handled.

This makes it possible to provide foamed hollow bodies or hollow spaces with efficient utilization of the capacity of mass production technology and without inserted processes for handling and storing separate parts. This in turn allows a considerable simplification of the production and cost savings, particularly during the further processing of correspondingly manufactured profiled parts, and thus it makes it possible, on the one hand, for the manufacturer of profiled parts to use these user advantages to gain market shares and/or to take into consideration in his pricing the higher added value created at his facility. In addition, the proposed manufacturing process allows a superior and uniform process and quality control during the manufacture of insulated hollow bodies, in particular insulated frame profiles, and thus leads to a reliable product quality for the end user.

In an embodiment of the method according to the invention, it is provided that the plastic spraying apparatus is supplied, like an extruder or an injection molding machine, with solid starting material in granulate form. Solid granular starting material can easily and cost effectively be packaged, stored and processed with little residue and thus it offers considerable advantages compared to liquid or pasty formulations.

In a further embodiment of the invention, it is provided that a plastic spraying apparatus with at least one screw conveyor is used, and the plastic spraying apparatus is configured in such a manner, and the mechanical properties of the starting material are predetermined in such a manner, that high pressures and/or shearing forces occur, which contribute to a thermal activation of the starting material. In this embodiment, it is possible, under some circumstances, to dispense with an additional heating device of the plastic spraying apparatus, and to operate in a particularly energy-saving manner. In an additional embodiment, a plastic spraying apparatus with a heating device is used, and the heating device is operated in such a manner that it at least contributes to a thermal activation of the starting material. A combination of the two ways of activating the starting material is also possible.

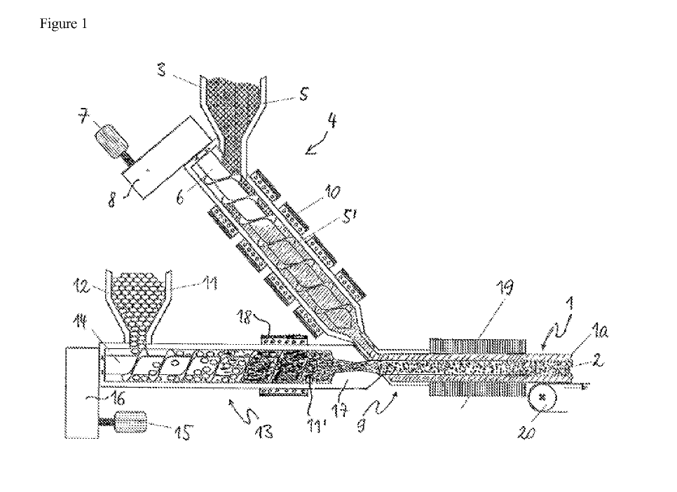

In FIG. 1, a coextrusion method according to the invention for manufacturing profiled plastic parts 1 with a foamed insulation core 2 is represented diagrammatically.

In the process the funnel 3 of a first extruder 4 is filled with a solid, thermoplastically processable plastic 5. This plastic can be in any desired form. In particular, the plastic is in the form of a granulate or powder. The plastic is preferably extruded at a temperature of 150° C. to 350° C., in particular of 170° C. to 260° C., preferably of 180° C. to 220° C. The plastic 5 reaches the interior of the first extruder 4 through the funnel 3. Here, the plastic is conveyed by means of a screw conveyor 6, which is operated by a motor 7 via a transmission 8, in the direction of a nozzle 9, and at the same time it is heated from the outside by heating elements 10, which are arranged on the first extruder, to a temperature above its melting point, resulting in the melting of the plastic. The molten plastic 5′ is pressed through the nozzle 9, which has the cross-sectional shape of the profile to be manufactured.

In parallel, a foamable composition 11, in particular in the form of a granulate, is filled into the funnel 12 of a second extruder 13 and it then reaches, through said funnel, the interior of the second extruder. The foamable composition is conveyed by means of a screw conveyor 14 which is driven by a motor 15 via a transmission 16 in the direction of a nozzle 17. By means of an appropriate geometric configuration of the screw and of the screw cylinder, high pressures and shearing forces are generated in a targeted manner in the process, leading to a softening and to an activation of the originally solid granulate, and an additional heating device 18 supports this process.

At the nozzle 17, the activated foamable composition 11′ is coextruded with a nearly immediate expansion, which is controlled by a special geometric configuration of the nozzle, into the hollow space of the hollow profiled plastic part 1a, where it comes in contact with the inner walls of the plastic hollow profile. The introduction of the profiled plastic part 1 into a calibration device 19 here should ensure that the hollow profiled plastic part is not deformed by the pressure of the foamed composition up to the setting of the plastic, but rather keeps its predetermined cross-sectional shape.

After the calibration device 19, the profiled plastic part 1 optionally passes through a separate cooling device, wherein it reaches, for example, a water bath or is sprayed by water showers. At the end of the coextrusion process, the profiled plastic part 1 is pulled off via a pull-off device 20 at a constant speed adapted to the delivery rate of the extruder.

The above-described foamable compositions can be used to manufacture windows and door profiles which can be welded without soiling the profiles, which allow a mechanical processing (for example, SFS 4.3 mm solid window construction screw) and which satisfy the high fire protection requirements of windows (B2 difficult to ignite according to ISO 14351 (product standard window) and DIN 4109 (material). At the same time, the materials are odorless during processing, any dust produced is not hazardous to health, and a further reduction of the Uf value is possible.

Below, foamable compositions according to the invention and polymer foams as described above are illustrated based on examples; however, they should in no way be considered to limit the scope of protection of the present invention.

### EXAMPLES

### Example 1

Different LDPE foams were manufactured using an extruder (Coperion ZSK 25). All the investigated foams contained LDPE as base polymer, propellant and a mixture of glycidyl group-containing polymers (crosslinking agent 1) and of a maleic acid group-containing polymer (crosslinking agent 2) as crosslinking agent. As propellant, azobisformamide was used. The compositions investigated are indicated in the following Table 1:

TABLE 1

| | Sample 1 | Sample 2 | Sample 3 | Sample 4 |
|---|---|---|---|---|
| LDPE | 82.00 | 81.06 | 80.12 | 79.18 |
| Crosslinking agent 1 | 2.5 | 2.47 | 2.44 | 2.41 |
| Crosslinking agent 2 | 2.5 | 2.47 | 2.44 | 2.41 |
| Propellant | 13.00 | 13.00 | 13.00 | 13.00 |
| Heat stabilizer | | 1.00 | 2.00 | 3.00 |

The foam obtained was then subjected to a heat treatment at 180° C. on a metal grid treated with PTFE film. The expansion behavior of the foam stabilized with a heat stabilizer (samples 2 to 4) exhibited clear differences compared to sample 1. While all the foams exhibited maximum expansions of approximately 2000%, the foam produced without heat stabilizers starts to shrink after approximately 10 minutes. After approximately 30 minutes, its volume has decreased to approximately 50% of the maximum volume. The maximum volume reached with sample 1 is also approximately 5 to 10% smaller than in the case of the other foams. In contrast, samples 2 to 4, with the same thermal treatment, exhibit a clearly less pronounced shrinkage behavior, wherein, with samples 2 and 3 (contents of 1 to 2% by weight of heat stabilizer), nearly no change in the maximum expansion is observed. In the case of sample 4, the foam loses approximately 5% of its maximum volume; however, this is substantially less than with sample 1.

1. A foamable composition comprising
a) at least one base polymer;
b) at least one propellant; and
c) at least one lubricant and/or at least one heat stabilizer.

2. The foamable composition according to claim 1, wherein the base polymer has a melting point of 20° C. to 400° C.

3. The foamable composition according to claim 1, wherein the base polymer is selected from the group consisting of EVA, polyolefin, PVC and XPS (crosslinked polystyrene).

4. The foamable composition according to claim 1, wherein the propellant is selected from the group consisting of azodicarbonamides, sulfohydrazides, hydrogen carbonates and carbonates.

5. The foamable composition according to claim 1, wherein the heat stabilizer is selected from the group consisting of fatty acid amides, fatty acids and fatty acid alcohol esters.

6. The foamable composition according to claim 1, wherein the content of heat stabilizer and/or lubricant in the composition is in the range of 0.1% to 5% by weight.

7. The foamable composition according to claim 1, wherein the composition includes, in addition, at least one crosslinking agent.

8. The foamable composition according to claim 7, wherein the crosslinking agent includes a mixture of an epoxy-containing polymer and of a maleic acid group-containing polymer.

9. The foamable composition according to claim 1, wherein the composition includes, in addition, at least one heat reflector, at least one heat loss additive, at least one anticondensation additive and/or at least one filler.

10. The foamable composition according to claim 9, wherein graphite, carbon black and/or titanium oxide is/are included as the at least one heat reflector.

11. A polymer foam obtained by expanding a composition according to claim 1.

12. A polymer foam, having a heat conductivity of <0.04 W/(mK), an expansion of ≧1000% and/or a weldability of approximately 80 seconds at 240-260° C.

13. A method of filling a hollow space in a hollow body, the method comprising filling the hollow space with the foamable composition of claim 1.

14. A foam filled hollow body, comprising at least one hollow space which is filled with the polymer foam according to claim 11.

15. A method of producing a foam-filled hollow body the method comprising introducing the composition according to claim 1, into at least one hollow space of the hollow body and then foaming the composition.

16. The foamable composition according to claim 2, wherein the melting point of the base polymer is 60° C. to 200° C.

17. The foamable composition according to claim 5, wherein the heat stabilizer has a chain length of 6 to 24 carbon atoms of the fatty acid or of the fatty acid alcohol portion.

18. The foamable composition according to claim 6, wherein the content of the heat stabilizer and/or lubricant is in the range of 0.5% to 3% by weight.

19. The foamable composition according to claim 7, wherein the crosslinking agent is a peroxide compound or an epoxy compound.

20. The foamable composition according to claim 12, wherein the expansion is ≧1500%.

21. The foamable composition according to claim 12, wherein the expansion is ≧2000%.

22. The method according to claim 13, wherein the hollow body is a window or door profile.

23. The method according to claim 14, wherein the hollow body is a window or door profile.

24. The method according to claim 15, wherein the foamable composition is introduced during extrusion of the hollow body.
